(19) United States
(12) Patent Application Publication
(10) Pub. No.: US 2008/0258075 A1
(43) Pub. Date: Oct. 23, 2008

(54) Ionizing Radiation Treatment System on Water-Borne Platform

(75) Inventors: Darren S. McKnight, Centreville, VA (US); Sik-Lam Wong, Berkeley, CA (US); Peter Sincerny, Castro Valley, CA (US); A. Anton Frederickson, Oak Hill, VA (US); Frank K. Childers, Hayward, CA (US)

Correspondence Address: ROTHWELL, FIGG, ERNST & MANBECK, P.C., 1425 K STREET, N.W., SUITE 800, WASHINGTON, DC, 20005, US

(73) Assignee: The Titan Corporation, San Diego, CA (US)

(21) Appl. No.: 10/590,865

(22) PCT Filed: Feb. 28, 2005
(86) PCT No.: PCT/US05/06343

§ 371 Date: Sep. 11, 2007

Related U.S. Application Data
(60) Provisional application No. 60/547,563, filed on Feb. 26, 2004.

(51) Int. Cl. H01J 27/00

(52) U.S. Cl. 250/424; 250/423 R

(57) ABSTRACT

An ionizing radiation treatment system is provided on a water-borne platform that includes areas for loading, treating, and unloading contaminated materials.

### CROSS-REFERENCE TO RELATED PROVISIONAL APPLICATION

This application claims the benefit under 35 U.S.C. § 119(e) of the Feb. 26, 2004 filing date of Provisional Application Ser. No. 60/547,563, the entire contents of which are incorporated herein by reference.

### BACKGROUND OF THE INVENTION

1. Field of the Invention

The present invention generally relates to treatment of contaminated material through ionizing radiation. In particular, the present invention relates to systems and methods for decontaminating materials using a water-borne platform.

2. Description of the Background Art

Radiation has long been used in food processing, medical device sterilization, and polymer production, but only recently has it begun to be widely accepted as a valued component in environmental cleanup initiatives and responses to potential or actual terrorist threats. The growing popularity of radiation as a means of neutralizing both natural and synthetic contaminants is due, in great part, to impressive results recently achieved by researchers worldwide using ionizing radiation methods, especially those involving electron beam techniques.

Existing ionizing radiation treatment systems can clean a multitude of contaminated materials such as medical devices and mail contaminated with toxins such as anthrax. While such systems provide a useful means to clean contaminated material, they are not conducive to rapid deployment and in some cases do not provide the public, employees, or ionizing radiation treatment system operators with adequate shielding. Consequently, there exists a need in the art for improvement in radiation-based decontamination systems.

### SUMMARY OF THE INVENTION

The present invention provides an ionizing radiation system that is highly mobile, by incorporating an ionizing radiation system into a water-borne platform. The present invention has several advantages over existing ionizing radiation treatment systems. The water-borne platform exploits the “intrinsic shielding” provided by a barge or other water-going vessel, in terms of isolation from land-based persons and objects.

Further, the neighboring water and surrounding structures against which the vessel may be moored can provide a “field expedient shielding” for the system. Furthermore, steel, lead, concrete, or other high density material, which is designed into the system as needed, can complete a total radiation shielding solution. Therefore, by reducing the magnitude of dedicated shielding required for the ionizing radiation treatment system, the present invention has greater transportability, enhanced flexibility of treatment operations, lower cost of the system, and a lower cost of treatment per pound of material processed than existing “fixed-site” radiation processing systems.

As a result of the mobility of non-stationary embodiments of the present invention, the invention also allows for rapid deployment of an ionizing radiation treatment system directly to the site of an acute crisis, or to the site of an on-going condition requiring decontamination or pathogen reduction, such as in bulk materials contaminated or infiltrated with any of a host of toxins, including naturally-occurring pathogens or infestations, biological warfare pathogens, chemical warfare agents, or other toxic materials.

Additionally, existing ionizing radiation treatment systems can be found in a wide range of occupational settings, including health care facilities, research institutions, nuclear reactors and their support facilities, nuclear weapon production facilities, and other various manufacturing settings. These radiation sources can pose a considerable health risk to affected workers. Therefore, the present invention may help alleviate this risk by processing contaminated materials at locations remote from populated areas and away from the presence of other workers not involved in the decontamination process. Thus, the present invention allows for safer decontamination of contaminated materials.

### BRIEF DESCRIPTION OF THE DRAWINGS

The invention will become more clearly understood from the following detailed description in connection with the accompanying drawings, in which:

FIGS. 1A and 1B are diagrams of one example of a preferred embodiment of the invention in the form of a water-borne platform with a vertical configuration of an ionizing radiation treatment system; and

FIGS. 2A and 2B are diagrams of a second example of a preferred embodiment of the invention in the form of a water-borne platform with a horizontal configuration of an ionizing radiation treatment system.

### DETAILED DESCRIPTION OF THE PREFERRED EMBODIMENTS

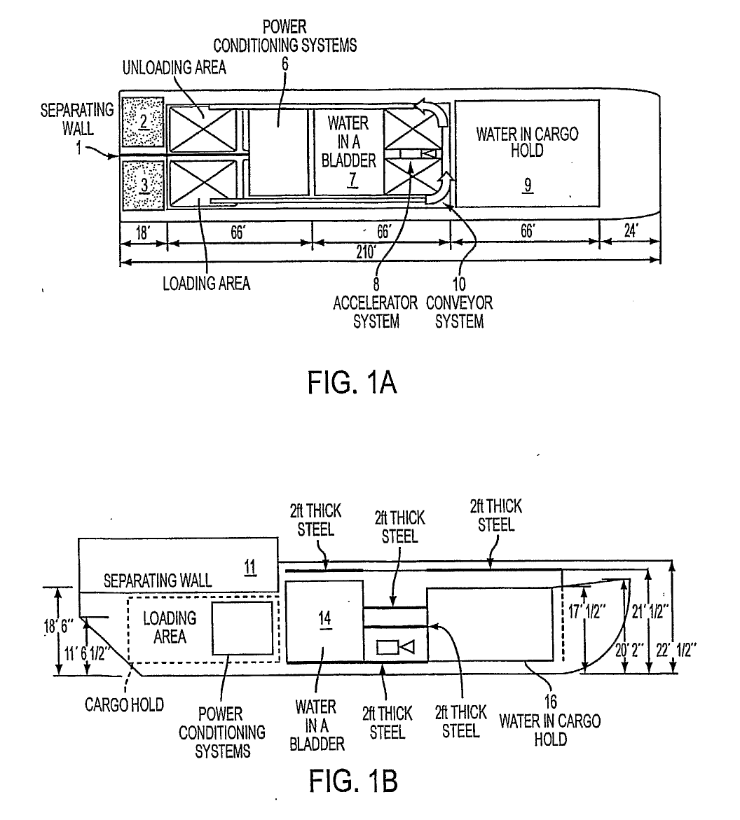

According to one preferred embodiment of the invention as shown in FIGS. 1A (top view) and 1B (side view), an ionizing radiation treatment system is provided on a water-borne platform, such as a barge, with a vertical configuration. In this embodiment, contaminated material may be first loaded into a “hot zone” (3) designated for holding contaminated material. From the hot zone (3), the contaminated material is moved to a loading area (5) where it can be moved onto a moving means, preferably a conveyer belt (10), which can transport the material to an area where the material may be decontaminated by a radiation accelerator system (8).

The accelerator (8) produces large amounts of radiation. Therefore, water in a cargo hold (9 & 16), and the water in a bladder (7 & 14), maybe be provided for shielding. Note that the cargo hold (9, 16) is shown in FIGS. 1A-1B as being larger than the bladder (7, 14) in order to provide additional shielding from the accelerated that is pointing towards the front of the barge.

Decontaminated materials are then preferably transported by the conveyer belt (10) to a “cold zone” (2) designated for clean materials only. First, the material is unloaded in an unloading area (4 & 11) and then moved to the cold zone (2). The cold zone (2) may be located horizontally with respect to the hot zone (3).

As shown in FIG. 1A, the loading area (5) and hot zone (3) can be isolated from the unloading area (4) and cold zone (3) by a separating wall (1, 11). As shown in FIG. 1B, the separating wall is extends above the deck of the barge to separate the hot and cold zone. The separating wall (11) can be constructed of high density material such as concrete.

Appropriate power conditioning systems (6) are provided as a source of electrical power for the accelerator system 8 and other components of the ionizing radiation treatment system.

In preferred embodiments, thick steel shielding, such as two foot (2′) thick steel walls (15), may be position throughout the barge for additional radiation shielding. As shown in FIG. 1B, the steel walls (15) are located to be adjacent to and to provide shielding for the accelerator system (8) and the water in the cargo hold (9 & 16) and in the bladder (7 & 14), which will become irradiated during the decontamination process.

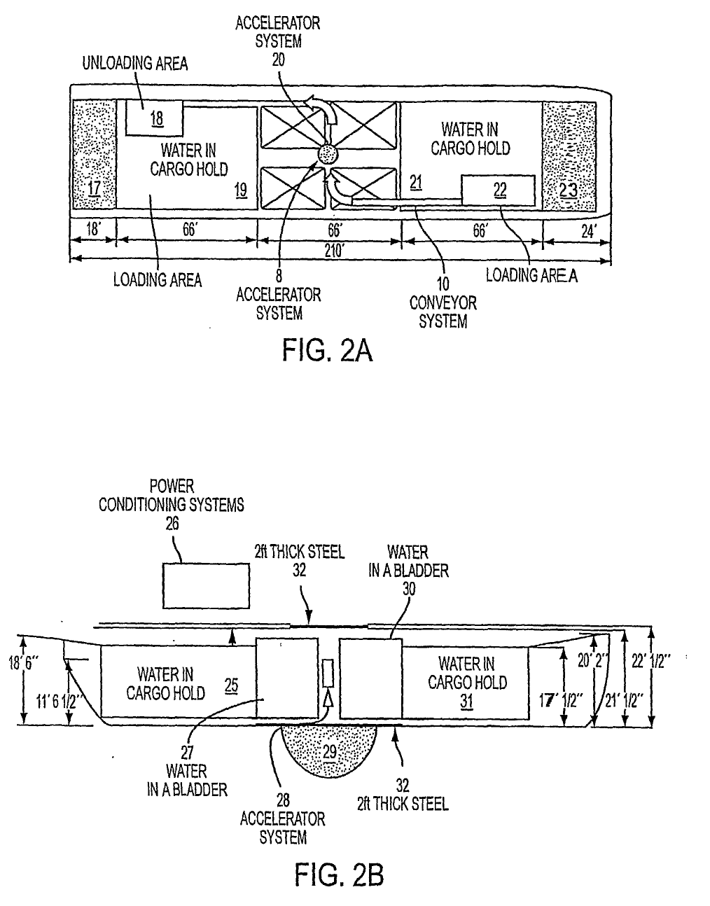

According to another preferred embodiment of the invention, a horizontal configuration of a waterborne ionizing radiation treatment system is illustrated in FIGS. 2A (top view) and 2B (side view). The system includes a hot zone (23) and a cold zone (17) provided at opposite horizontal ends of the barge. Similar to the embodiment of FIGS. 1A-1B, in this embodiment, contaminated materials can be loaded into the loading area (22) from the hot zone (23). The material is transported, preferably on a conveyor system (24), to the center of the ship to be decontaminated by an accelerator radiation system (20 & 28). Treated materials then move preferably on a conveyer belt (24) to an unloading area (18) where the materials can be placed into the cold zone (17) that is located on the opposite end of the ship. Subsequently material may be removed from the cold zone (17).

The accelerator (28) can be aimed downward in this configuration to take advantage of the intrinsic shielding of the water in which the barge is located. A “keep out zone” (29) can be located below the accelerator system (20 & 28) as a measure of protection against undesired radiation.

Additionally, in some embodiments of the horizontal configuration, the water in the cargo hold (19, 21, 25, & 31) can be located on either side of the accelerator system (20 & 28). Further, the water in the bladder (27 & 30) can also be located on either side of the accelerator system (20 & 28).

In other embodiments of the horizontal configuration, the accelerator system (20 & 28) can be further shielded by steel walls or plates (32), which can be of a sufficient thickness such as, e.g., 2 feet (2′) thick above and below the accelerator system.

The power conditioning system (6, 13, and 26) can change the form of an electric current (e.g. can change a battery produced DC current into an AC current or can smooth out a rough AC current) to provide an appropriate supply of electrical power for operation of the various components of the radiation treatment system. After the source of electrical current is modified by the power conditioning system (6, 13, and 26) the conditioned electrical current can then be applied to a power grid.

In another preferred embodiment of the invention the water-borne platform is capable of motion; however, the system also may be implemented as a stationary device that is located in a body of water. Moreover, in some embodiments the materials are processed (decontaminated) while the platform is moving and in other embodiments the materials are processed while the platform is stationary.

Some preferred embodiments of the invention can decontaminate a multitude of varying types of materials including, but not limited to: food, mail, contaminated bulk materials, mulch, soil, chemicals, biological material, byproducts resulting from surface, personal, or large area decontamination processes, medical components, and mass fatalities management.

Additionally, the preferred embodiments can also be used to proactively treat materials that may be contaminated. In some cases said proactive treatment is done as a precautionary means of mitigating a contamination threat, whether such contamination might result form unintentional acts, intentional acts, or acts of nature.

In some preferred embodiment of the present invention, the platform has several different types of “intrinsic shielding,” including but not limited to: “field expedient shielding” provided by the neighboring water in which the vessel floats, surrounding structures against which the vessel may be moored, “dedicated shielding” from steel, lead, concrete, or other high density material, which is designed into the system as needed.

In other embodiments the water-borne ionizing radiation treatment system also contains an integrated radiation source, material handling hardware, contamination measurement/control systems, and process control systems to ensure efficient, safe, and effective handling of a wide variety of materials.

Additionally, the ionizing radiation treatment system is preferably an electron beam system, however it can also use other appropriate forms of radiation, such as X-rays, gamma rays, etc.

Furthermore, in some embodiments of the invention the invention is capable of rapid deployment directly to the site of a crisis or an on-going condition requiring decontamination or pathogen reduction in bulk materials contaminated or infiltrated with a multitude of contaminants.

In still other embodiments the invention can use water as a closed cycle surface decontamination fluid source. Further, other embodiments also have a spraying device that will take water from the vessel to be used for decontaminating contaminated material (e.g. people, surfaces, vehicles, etc.). The runoff from such treatments can be captured and returned to the water compartments (cargo hold or bladder). The system can also provide a large source of fluid for aqueous decontamination processes and provide a terminal for runoff so as not to contaminate the water supply and neighboring areas where the aqueous decontamination processes are executed. The fluid can then be piped back into the vessel and contained and remediated by its interaction with the e-beam or x-ray system operations. A separate treatment system could be provided for treating the water contained in the hull compartments, such as an ion exchanger.

The invention having been described, it will be apparent to those skilled in the art that the same may be varied in many ways without departing from the spirit and scope of the invention. Any and all such modifications are intended to be included within the scope of the following claims.

What is claimed is:

1. A water-borne ionizing radiation treatment system comprising:
an ionizing radiation treatment system; and
means for supporting said water-borne ionizing radiation treatment system on a body of water.

2. The water-borne ionizing radiation treatment system of claim 1, further comprising:
a hot zone for staging contaminated materials;
an accelerator system for decontaminating the contaminated materials;
a cold zone for storing the decontaminated materials; and
moving means for transporting the contaminated materials to the accelerator system, and for transporting decontaminated materials to the cold zone from the accelerator system.

3. The water-borne ionizing radiation treatment system of claim 2, wherein said hot zone and said cold zone are isolated from each other by a barrier.

4. The ionizing radiation treatment system of claim 2, wherein the supporting means further comprises water compartments adjacent to the accelerator system to provide radiation shielding.

5. The ionizing radiation treatment system of claim 2, wherein the accelerator system is aimed toward a bottom side of the supporting means.

6. The ionizing radiation treatment system of claim 1 wherein the supporting means includes a hull, structural members, or systems with increased thickness sufficient for radiation shielding.

7. The ionizing radiation treatment system of claim 2, wherein the accelerator system is aimed toward a front side of the supporting means, and said hot zone and said cold zone are located at a rear side of said supporting means.

8. The ionizing radiation treatment system of claim 2, wherein said accelerator system comprises an electron beam system.

9. The ionizing radiation treatment system of claim 2, wherein said accelerator system comprises an x-ray system.

10. The ionizing radiation treatment system of claim 1 wherein said ionizing radiation treatment system includes an independent power generation system.

11. A method of decontamination comprising the step of decontaminating material with an ionizing radiation treatment system located on a water-borne platform.

12. The method of claim 11 further comprising a step of providing radiation shielding by filling containers or compartments on said water-borne platform with water, and or filling the hull of said water-borne platform with water.

13. The method of claim 11 further comprising modifying the typical placement of said platforms hull, structural members, or systems to enhance the intrinsic radiation shielding of said platform.

14. The method of claim 11 wherein said step of decontaminating includes treating contaminating material with an accelerator system, said accelerator system comprising either an electron beam system or an x-ray system.

15. The method of claim 14, wherein said accelerator system is aimed downward toward a bottom side of said water-borne platform.

16. The method of claim 11, further said decontamination step is performed below the waterline within said water-borne platform.

17. The method of claim 11, wherein contaminated materials are routed to a “hot zone” and clean materials are routed to a “cold zone,” said hot zone and said cold zone being isolated from each other by a barrier.

18. The method of claim 12, further comprising a step of providing a spraying device to take water from the platform to decontaminate contaminated material.

19. The method of claim 18, further comprising a step of capturing the runoff of said spraying device and returning it to the platform water compartments.

20. The method of claim 19, further comprising a step of decontaminating the runoff from said spraying device using said ionizing radiation treatment system.
